(19) United States
(12) Patent Application Publication
(10) Pub. No.: US 2016/0224398 A1
(43) Pub. Date: Aug. 4, 2016

(54) Synchronization in a Multi-Processor Computing System

(71) Applicant: Intellisis Corporation, San Diego, CA (US)

(72) Inventors: Douglas A. Palmer, San Diego, CA (US); Mark A. Doyle, San Diego, CA (US); Doug B. Meyer, San Diego, CA (US)

(21) Appl. No.: 14/937,437

(22) Filed: Nov. 10, 2015

Related U.S. Application Data
(63) Continuation-in-part of application No. 14/608,693, filed on Jan. 29, 2015.

(51) Int. Cl. G06F 9/54; G06F 1/32

(52) U.S. Cl. CPC G06F 9/542; G06F 1/3296

(57) ABSTRACT

In one aspect, a system includes a device controller, processing clusters, and processing elements. The device controller includes a device event status register configured to store bits corresponding to (i) a global event signal provided by an external source and (ii) a device event signal provided by a device event control register. A processing cluster includes a cluster event register configured to store bits corresponding to (i) the global event signal provided by the external source, (ii) the device event signal provided by the device event control register, and (iii) a cluster event signal. A processing element includes an element event register configured to store bits corresponding to (i) the global event signal provided by the external source, (ii) the device event signal provided by the device event control register, (iii) the cluster event signal provided by the cluster event register, and (iv) a processing element event signal.

### CROSS-REFERENCE TO RELATED APPLICATION

This application is a continuation-in-part application of U.S. application Ser. No. 14/608,693, filed on Jan. 29, 2015, the entire contents of which are hereby incorporated by reference.

### BACKGROUND

This specification relates to synchronization within a multi-processor computing system.

Information-processing systems are computing systems that process electronic and/or digital information. Typical information-processing systems may include multiple processing elements, such as multiple single core computer processors, capable of concurrent and/or independent operation. Such systems may be referred to as multi-processor processing systems. Synchronization mechanisms in such systems commonly include interrupts and/or exceptions implemented in hardware, software, and/or combinations thereof. When multiple processing elements such as multiple processors execute in parallel to process data for one computation process, the interrupts and/or exceptions may not provide adequate synchronization between the processing elements.

### SUMMARY

This specification describes technologies relating to the synchronization of processing elements in a computing system. In one aspect, the subject matter described in this specification can be implemented in a system that includes a device controller, a plurality of processing clusters, and a plurality of processing elements. The device controller includes a device event control register and a device event status register. The device event status register is configured to store bits corresponding to (i) a global event signal provided by an external source and (ii) a device event signal provided by the device event control register. The plurality of processing clusters includes a first processing cluster that is connected with the device controller. The first processing cluster includes a cluster event register. The cluster event register configured to store bits corresponding to (i) the global event signal provided by the external source, (ii) the device event signal provided by the device event control register, and (iii) a cluster event signal. The plurality of processing elements includes a first processing element that is connected with the cluster event register. The first processing element includes an element event register. The element event register is configured to store bits corresponding to (i) the global event signal provided by the external source, (ii) the device event signal provided by the device event control register, (iii) the cluster event signal provided by the cluster event register, and (iv) a processing element event signal.

In another aspect, the subject matter described in this specification can be implemented in a computing system that includes a plurality of processing clusters, where a first processing cluster of the plurality of processing clusters includes a plurality of processing elements. The plurality of processing elements is configured to receive event signals from sources at levels higher in a system hierarchy than the plurality of processing elements. A first processing element of the plurality of processing elements includes a first element event register. The first processing element may perform a method including executing a first set of computing instructions; halting execution upon completion of the first set of computing instructions; receiving, from a source at a level higher in the system hierarchy, one or more event signals that set one or more corresponding event flags in the first element event register; determining that all required event flags are set in the first element event register; and in response to the determining, executing a second set of computing instructions.

These and other implementations can optionally include one or more of the following features. The device event control register may be configured to provide the device event signal based on data received from one of the external source, a processor of the device controller, a processing element of the plurality of processing elements, or a data feeder of a cluster memory. The cluster event register may be configured to provide the cluster event signal based on data received from one of the external source, a processor of the device controller, a processing element of the plurality of processing elements, or a data feeder of a cluster-level memory. The cluster event register may be configured to provide the processing element event signal based on data received from one of the external source, a processor of the device controller, a processing element of the plurality of processing elements, or a data feeder of a cluster-level memory. Each of the device event status register, the cluster event register, and the element event register may include asynchronous latches. Each processing element of the plurality of processing elements may include an element event register, and the cluster event register may be configured to provide the cluster event signal and the processing element event signal to each element event register of each processing element of the plurality of processing elements. A processor of the device controller may be configured to poll the device event status register, execute an interrupt routine, or sleep based on values of the bits stored in the device event status register. The first processing element may include event logic that may be configured to cause a change in a power consumption mode from a normal mode to a sleep mode of the first processing element when the first processing element executes a sleep command; while the first processing element is in the sleep mode, detect that an event condition is satisfied based on values of the bits stored in the element event register; and upon detecting that the event condition is satisfied, switch the power consumption mode of the first processing element from the sleep mode to the normal mode. The event logic of the first processing element may be configured to detect that the event condition is satisfied based on a logical AND of the values of the bits stored in the element event register. The event logic of the first processing element may be configured to detect that the event condition is satisfied based on a logical OR of the values of the bits stored in the element event register. The first cluster may include a state memory and an execution memory, and the element event register may be further configured to store bits corresponding to memory event signals provided by the state memory and the execution memory. The system may include a cluster memory connected with the cluster event register. The cluster memory may include a data feeder and a data feeder event register. The data feeder event register may be configured to store bits corresponding to (i) the global event signal provided by the external source, (ii) the device event signal provided by the device control register, (iii) the cluster event signal provided by the cluster event register, and (iv) a data feeder event signal. The cluster event register may be configured to provide the data feeder event signal based on data received from one of the external source, a processor of the device controller, a processing element of the plurality of processing elements, or the data feeder. The data feeder may be configured to begin execution of a set of instructions based on values of the bits stored in the data feeder event register. The cluster memory may include one or more memory devices, and the data feeder event register may be configured to store bits corresponding to memory event signals provided by the one or more memory devices. The system may include a second processing element of the plurality of processing elements. The second processing element may include a second element event register. The second processing element may perform a method including executing a third set of computing instructions; halting execution upon completion of the third set of computing instructions; receiving, from the source at the level higher in the system hierarchy, the one or more event signals that set one or more corresponding flags in the second element event register; determining that all required event flags are set in the second element event register; and in response to the determining, executing a fourth set of computing instructions. The device event status register may be connected to the plurality of clusters and may be configured to distribute event signals to the plurality of processing clusters. The cluster event register may perform a method including receiving, from the device event status register, one or more event signals that trigger the cluster event register to provide the one or more event signals that set the one or more corresponding flags in the first element event register. The cluster event register may perform a method including receiving, from the data feeder, one or more event signals that trigger the cluster event register to provide the one or more event signals that set the one or more corresponding flags in the first element event register. The first processing cluster may include one or more memory devices. The cluster event register may perform a method including receiving, from the one or more memory devices, one or more event signals that trigger the cluster event register to provide the one or more event signals that set the one or more corresponding flags in the first element event register. The cluster event register may perform a method including receiving, from the second processing element, one or more event signals that trigger the cluster event register to provide the one or more event signals that set the one or more corresponding flags in the first element event register.

Details of one or more implementations of the subject matter described in this specification are set forth in the accompanying drawings and description below. Other features, aspects, and potential advantages of the subject matter will become apparent from the description, the drawings, and the claims.

### BRIEF DESCRIPTION OF THE DRAWINGS

FIG. 1 is a block diagram showing an example of a multi-processor chip.

FIG. 2 is a block diagram showing data flow of event signals to a device controller of the processor chip.

FIG. 3 is a block diagram showing data flow of event signals to and from a cluster of the processor chip.

FIG. 4 is a block diagram showing data flow of event signals to and from a data feeder of the processor chip.

FIG. 5 is a block diagram showing data flow of event signals to and from an event register of a processing element of the processor chip.

FIG. 6 is a flowchart showing an example of a process for synchronizing execution of instructions in a computing system.

### DETAILED DESCRIPTION

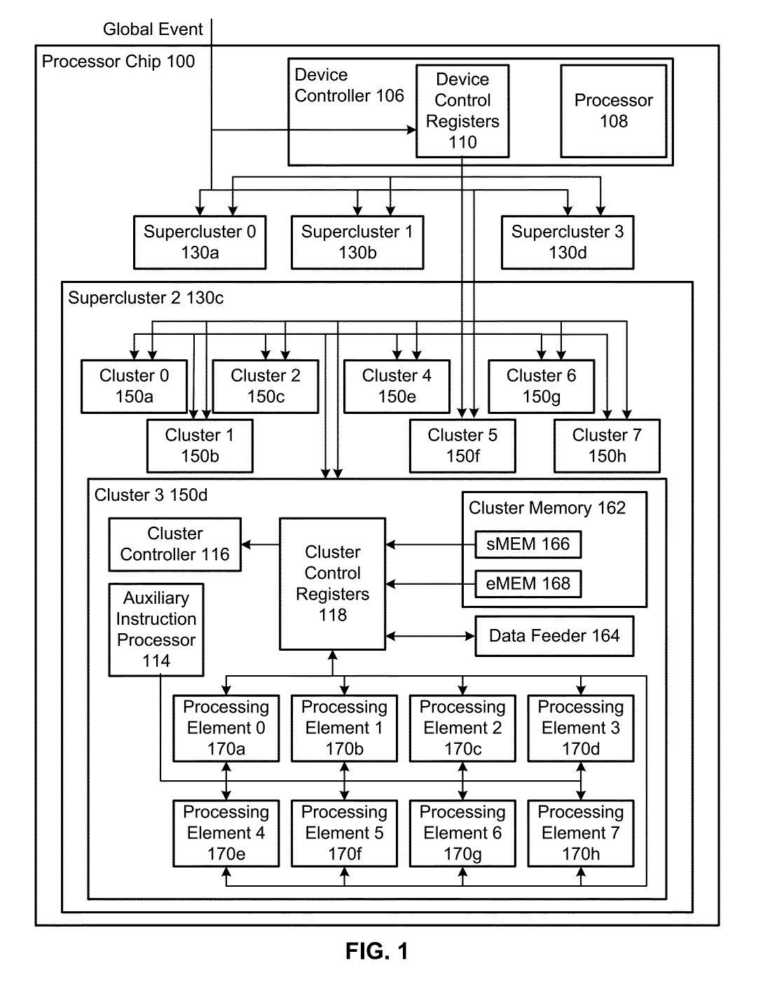

FIG. 1 is a block diagram showing an example of a multi-processor computing system, such as processor chip 100. In the example shown in FIG. 1, the processor chip 100 includes a large number of processing elements 170 (e.g., 256), connected together on the processor chip 100. The processor chip 100 includes four superclusters 130a-130d. Each supercluster 130 includes eight clusters 150a-150h. Each cluster 150 includes eight processing elements 170a-170h. Although four superclusters, eight clusters, and eight processing elements are shown in FIG. 1, the processor chip 100 can include any number of superclusters, clusters, and processing elements. Connections between the components of the processor chip 100 include examples of signaling and/or monitoring of events, status, and/or activity within the processor chip 100, but are not intended to be limiting in any way. The processor chip 100 may be included in a system that includes multiple processor chips 100 and other external sources, such as a host or a server, that communicate with each other to, for example, signal events among the processor chips and the external sources.

The processor chip 100 includes a device controller 106. The device controller 106 may control the operation of the processor chip 100 from power on through power down. The device controller 106 includes a processor 108 and device control registers (DCRs) 110.

Each cluster 150 includes a cluster controller 116, cluster control registers (CCRs) 118, an auxiliary instruction processor (AIP) 114, a cluster memory 162, a data feeder 164, and processing elements 170a-170h. The cluster controller 116 may be configured to provide communication and/or interaction between the CCRs 118, processing elements 170, AIP 144, data feeder 164, state memory (sMEM) 166, and execution memory (eMEM) 168.

The data feeder 164 may be a data sequencer that is coupled to the eMEM 166 and sMEM 168. The data feeder 164 may execute a program that is stored in the eMEM 166. The data feeder 164 may push data from the eMEM 166 and sMEM 168 to the processing elements 170 and other sources on or off the processor chip 100. The eMEM 166 and the sMEM 168 may be embedded dynamic memory such as a dynamic random access memory (DRAM).

Each processing element 170 may include a central processing unit (CPU) with an instruction set that may implement some or all features of modern CPUs, such as a multi-state instruction pipeline, one or more arithmetic logic units (ALUs), a floating point unit (FPU), or any other CPU technology. The AIP 114 may be a special processing element shared by all processing elements 170 of the cluster 150. The AIP 114 may be implemented as a co-processing element to the processing elements 170. The AIP 114 may implement less commonly used instructions such as some floating point arithmetic including, for example, addition, subtraction, multiplication, division, square root, sine, cosine, inverse, etc. The clock signals used by different processing elements of the processor chip 100 may be different from each other. For example, different clusters 150 may be independently clocked. As another example, each processing element may have its own independent clock.

Processing elements within a cluster 150 may share a cluster memory 162, such as a shared memory serving a cluster 150 including eight processing elements 170 and AIP 114. A data feeder 164 may execute programmed instructions which control where and when data is pushed to the individual processing elements. The data feeder 164 may also be used to push executable instructions to the program memory of a processing element for execution by that processing element's instruction pipeline.

Multiple components within the processor chip 100 may be configured to operate independently on particular tasks, functions, and/or sets or sequences of instructions, which may be jointly referred to as a process. Performing a process may be referred to as running a process. For example, a processing element performing a process may be referred to as a process “running on” the processing element. Independent operation of multiple components may be limited in time. For example, once a particular event occurs, previously independent operation of two processing elements may cease and synchronized or lock-step operation may start or resume.

Multiple components within the processor chip 100 may be configured to operate on related and/or unrelated processes. For example, a first processing element may perform a mathematical function on a first set of data, while a second processing element may perform a process such as monitoring a stream of data items for a particular value. The processes of both processing elements in this example may be unrelated and/or independent. Alternatively, these processes may be related in one or more ways. For example, the first processing element may perform the mathematical function only after the particular value has been found in the process running on the second processing element. Alternatively, the first processing element may cease performing the mathematical function after the particular value has been found in the process running on the second processing element. Alternatively, and/or simultaneously, the mathematical function running on the first processing element and the process running on the second processing element may be started and/or stopped together, for example under control of a process running on a third processing element. For example, the mathematical function running on the first processing element, the process running on the second processing element, and/or other processes may be part of an interconnected set of tasks that form an application.

Processes to be executed by one or more processing elements may be nested hierarchically and/or sequentially. For example, a first processing element may perform a first mathematical function on a first set of data, while a second processing element may perform a different function on a second set of data that includes—as at least one of its input—one or more results of the first mathematical function (e.g., in some implementations, a set or stream of values may be the result of the first mathematical function). In this example, the processes of both processing elements are related and/or dependent, e.g., hierarchically and/or sequentially.

The processor chip 100 may assign a sequence of tasks (e.g., an application) to the processing elements. In some implementations, data (program code and/or pieces of information upon which the program code operates) needed to execute the sequence of tasks on the processing elements may come from outside of the cluster 150 that includes the processing elements. For example, the tasks may be assigned by a host device connected to the processor chip 100. The host may load the tasks, assign the tasks to the processing elements of the processor chip 100, and send the data for the assigned tasks to the processing elements respectively.

Event, condition, status, activity and any other information related to the operating state of the components of the processor chip 100 may be generated, counted and/or collected at different levels of the hierarchy of the processor chip 100. The components within the processor chip 100 may generate and send signals to indicate one or more occurrences of one or more events related to the components. As used herein, signals indicative of events may be referred to as event signals and the term “event” may also mean the signal representing an occurrence of the event. An event may interchangeably refer to any event, condition, status, activity (or inactivity) of a component of the processor chip 100. For example, an event may be related to and/or associated with a cluster memory 162, an AIP 114, or a processing element 170. An event may be related to and/or associated with a (completion of an) execution of an instruction and/or task within a cluster memory 162, an AIP 114, or a processing element 170.

In addition to propagating event signals, the processor chip 100 and the components within the processor chip 100 may generate event signals. For example, the processor chip 100 may generate an event signal based on activity of a specified subset or all of the components within the processor chip 100 to indicate an activity for the processor chip 100 as a whole. As another example, a cluster 150 may generate an event signal based on activity of a specified subset or all of the components within the cluster 150 to indicate an activity for the cluster as a whole. For example, if only the processing elements 170a and 170b have been assigned tasks to execute, a cluster level event may be generated based on activity of the processing elements 170a and 170b instead of all processing elements 170a-170h in the cluster 150.

The event signals may be received at event registers at different hierarchical levels of the processor chip 100 and stored in the event registers as event flags. The event flags may comprise one or more bits and each event flag represents a Boolean state that may be in a “set” or “non-set” value. A “set” value may indicate the event represented by the event flag has occurred and a “non-set” value may indicate that the event represented by the event flag has not occurred. When an event signal arrives at a destination, an event flag is set. Therefore, the event flag may be used to represent states of a respective component. Table 1 below lists examples of events and their source and destination components.

TABLE 1

| Event name | Mnemonic | Source | Destination | Notes |
|---|---|---|---|---|
| Global | EVFG[3:0] | External | DCR, cluster | Global events are |
| | | source | controller, data | provided by an external |
| | | | feeder, processing | source via pins of the |
| | | | element | processor chip and |
| | | | | distributed to all |
| | | | | destinations. |
| Device | EVFD[3:0] | DCRs | Cluster controller, | Any writer of the DCRs |
| | | | data feeder, | can generate these |
| | | | processing element | signals. The DCRs |
| | | | | distributes these signals |
| | | | | to all destinations. |
| Cluster | EVFC[3:0] | CCRs | Processing elements | Any writer of the CCRs |
| | | | and data feeder | can generate these |
| | | | within the cluster | signals. |
| Data feeder | EVFF[7:0] | CCRs | Data feeder within | Any writer of the CCRs |
| | | | the cluster | can generate these |
| | | | | signals. |
| Processing | EVFT[3:0] | CCRs | Processing element | Any writer of the CCRs |
| element | | | within the cluster | can generate these |
| | | | | signals. |
| eMEM | EVFCWE | eMEM | Processing element, | These signals are |
| counted wait | | | data feeder within | generated by the cluster |
| | | | the same cluster | controller as a result of |
| | | | | eMEM write-with- |
| | | | | decrement operation. |
| sMEM | EVFCWS | sMEM | Processing element, | These signals are |
| counted wait | | | data feeder within | generated by the cluster |
| | | | the same cluster | controller as a result of |
| | | | | sMEM write-with- |
| | | | | decrement operation. |
| Processing | EVFCWL | Processing | Another processing | These signals are |
| element | | Element | element within the | generated as a result of |
| counted wait | | | same cluster | a processing element |
| | | | | write-with-decrement |
| | | | | operation. |
| Mailbox | EVFMBX | Mailbox of | Processing element | These signals are |
| | | processing | event register | generated by a write to |
| | | element | | the processing element |
| | | | | mailbox. |
| AIP | EVFAIP | AIP | Processing element | These signals are sent to |
| | | | within the same | the particular processing |
| | | | cluster | element that issued an |
| | | | | AIP instruction when |
| | | | | the instruction |
| | | | | completes. |
| Mutex | EVFMTX | AIP | Processing element | These signals are sent to |
| | | | within the same | the particular processing |
| | | | cluster | element that issued a |
| | | | | TRYMTX command. |
| Packet | EVFPKT[0:3] | Various | Processing element | Packet events are |
| | | | | carried in packets for |
| | | | | targeting the processing |
| | | | | element that is to |
| | | | | receive the packet event. |

The DCRs 110 can be written by any executing thread (e.g., a host, a device controller, a processing element, or a data feeder) via a write packet from the thread to cause a device event. For example, any processing element 170 of the processor chip 100 can write to the DCRs 110 to cause a device event. The CCRs 118 can be written by any executing thread (e.g., a host, a device controller, a processing element, or a data feeder) via a write packet from the thread to cause a cluster event, a data feeder event, or a processing element event. For example, any processing element 170 can write to the CCRs 118 within the same cluster 150 to cause a cluster event, a data feeder event, or a processing element event. Additionally, an external source (e.g., a host or a server) can write to various registers within the processor chip 100 via write packets to generate corresponding events.

Packet events are received by the processing elements 170. Packet events may be transmitted as part of a data packet targeted at a processing element 170. Packet events can be generated by a host, any device controller 108, any data feeder 164, or any processing element 170. For example, any processing element 170 can send data packets to another processing element 170 to cause a packet event.

A counted wait event may be used to signal when a required number of write-with-decrement data packets have been processed in a particular memory address range. An eMEM counted wait event may cover the entire address range of the eMEM 168. The scope of the eMEM counted wait event is the cluster 150 containing the eMEM 168. The data feeder 164 and all processing elements 170 within the cluster 150 may wait for this event. A sMEM counted wait event may cover the entire address range of the sMEM 166. The scope of the sMEM counted wait event is the cluster 150 containing the sMEM 166. The data feeder 164 and all processing elements 170 within the cluster 150 may wait for this event. The processing element counted wait event covers all of the processing element memory range except for the processing element mailbox registers. The scope of the processing element counted wait event is limited to the processing element that is being written, and the event is internal to the processing element where it is generated. This event may allow the processing element to go to sleep until all the data it needs arrives.

Aside from the packet events, which are carried in packets that are point-to-point, all other event signals are distributed throughout the processor chip 100 based on the scope of the event. These non-packet event signals can be asynchronous event signals that are latched by event registers on the rising edge of the event signal pulse. Each event register may be configured to support being set and/or programmed to a particular value, to be cleared to a particular (default) value, to be read or polled such that its value may be inspected, and/or may support other operations related to its value. A particular event flag may be set to a value that indicates a particular event and/or condition has occurred through a write operation to a register at the same level of hierarchy as the associated component, or a write operation to a register at a different level of hierarchy within the processor chip 100, including but not limited to the cluster level, the chip level, and/or another level. For example, a cluster may include an event register that corresponds to individual events for components within the cluster.

In some implementations, a write operation may cause a (transitory) signal to have a pulse of sufficient width to be correctly detected, and this pulse (or copies thereof) may in turn be routed to a corresponding bit of an event register, and cause the bit of the event register to be set. In addition, in some implementations, state changes within the processor chip 100 may cause a transitory signal to have a pulse of sufficient width and this pulse (or derivatives thereof) may in turn cause event register bits to be set or cleared. The width of the pulse can be configured to be long enough to meet timing requirements for the latches of the event registers at every destination. For example, the width of the pulse may be two to three clock cycles long.

The event signals can be used to provide synchronization at scopes ranging from an entire processor chip to individual components, such as individual processing elements and data feeders, of the processor chip. A thread of execution (e.g., a processing element, a data feeder, or the device controller) can be configured to wait for a subset of event signals and suspend execution until all of the required event flags are set. By way of example, two or more processing elements may need to be synchronized at some point in order for the next task in the sequence of tasks to continue on a processing element, which could be any of the processing elements within the same cluster, a processing element in a different cluster, or a processing element in a different processor chip. Although for ease of explanation the above example describes assigning two tasks to two processing elements, any number of tasks can be assigned to any number of processing elements at the processing element level, the cluster level, or the super cluster level.

A component of the processor chip 100 may include instructions that effectuate generation of event signals (e.g., setting a particular event flag) and/or information (e.g., generating a packet of information) that indicate a particular event (e.g., status, condition, or activity) of the component. For example, an event may be that a particular point in a program or a particular task in an application has been reached, initiated, or completed. The component waiting for the event signal may take appropriate actions, such as resume a task that the component may have stopped, send data to another component, or coordinate with another component to work on the next task in the sequence of tasks upon detecting that the corresponding event flag is set. Synchronization between components need not be limited to a single cluster or super cluster, but may extend anywhere within the processor chip and/or between multiple processing chips. For example, if any of the scenarios described herein where a second component is configured to take appropriate actions upon detection (or being notified) of an event related to a first component, the second component may be part of a different cluster, super cluster, or processor chip than first component.

Synchronization between processing elements may be based on, among other features, an ability of the processing elements to reversibly suspend their own execution, which may be referred to as “going to sleep.” Synchronization between processing elements need not be limited to a single cluster or super cluster, but may extend anywhere within a processor chip and/or between multiple processor chips in a computing system.

In some implementations, a particular processing element may be configured to execute one or more instructions (from a set of instructions) that reversibly suspend execution of instructions by that particular processing element. Other components within a processor chip, including but not limited to components at different levels within a hierarchy of a processor chip, may be configured to cause such a suspension to be reversed, which may be referred to as “waking up” a (suspended) processing element.

Processing elements may be configured to have one or more modes of power consumption, including a low-power mode of consumption (e.g., when the processing element has gone to sleep) and one or more regular power modes of consumption when execution is not suspended. In some implementations, the low power mode of consumption reduces power usage by a factor of at least ten compared to power usage when execution is not suspended. In some implementations, waking up a processing element may be implemented as exiting the low-power mode of power consumption.

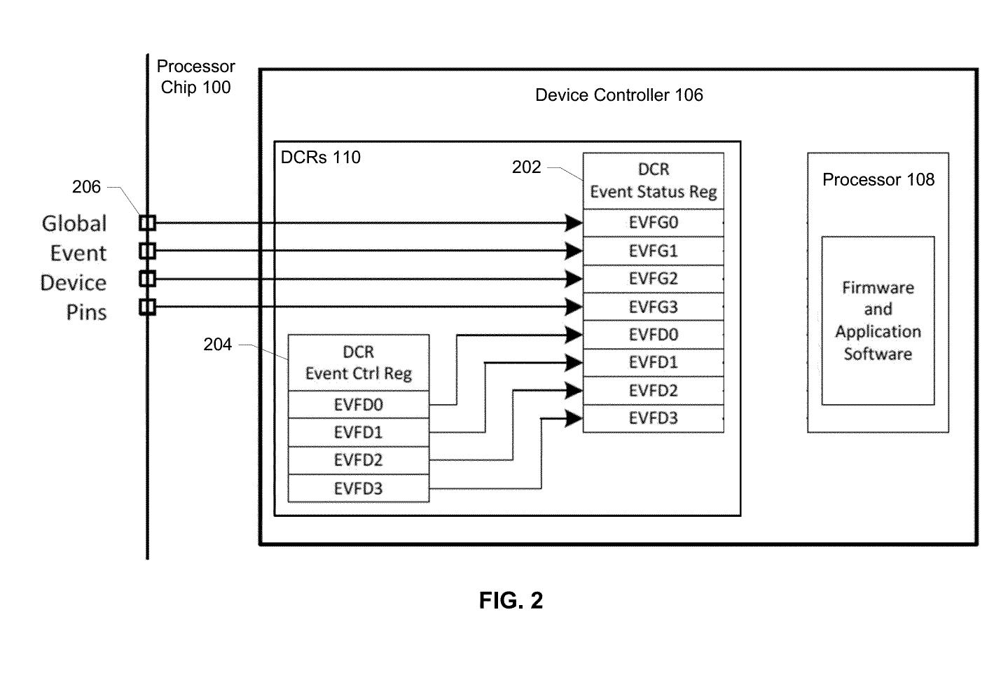

FIG. 2 is a block diagram showing data flow of event signals to the device controller 106 of the processor chip 100. The processor 108 of the device controller 106 runs device-level control plane code and may also run application code. Although the processor 108 never stops performing control plane operations, both of these code flows may require the use of events for synchronization at the global and/or device scope.

A device event status register 202 latches all global events and device events. The device event status register 202 gives the processor 108 visibility to the global events and the device events. Each bit in the device event status register 202 is latched on the rising edge of the corresponding event pulse. The latched value persists until explicitly cleared by the processor 108. The device event status register 202 may be cleared by writing a “1” to any bit position to clear the bit. The processor 108 monitors, interprets, and acts upon the event flags. Use of events within the device controller 106 is determined by code running on the processor 108.

The global event signals may be provided by an external source (e.g., a host) via pins 206 of the processor chip 100. Each global event signal may be latched on the rising edge of the pulse, and each global event flag of the device event status register 202 can be cleared by the processor 108.

The device controller 106 is the source of the device event signals. A device event control register 204 generates the device event signals. The device event control register 204 can be written by the processor 108 or any executing thread (e.g., a host, a processing element, or a data feeder) via a write packet from the thread. As shown in FIG. 2, there are four device event signals that can be generated and distributed to all destinations within the processor chip 100. Asserting any un-asserted bit within the device event control register 204 will generate the corresponding device event signal to the entire processor chip 100. The processor 108 clears an asserted bit of the device event control register 204 before it can re-assert it. The value of each bit of the device event control register 204 may be toggled by writing a “1” to that bit position.

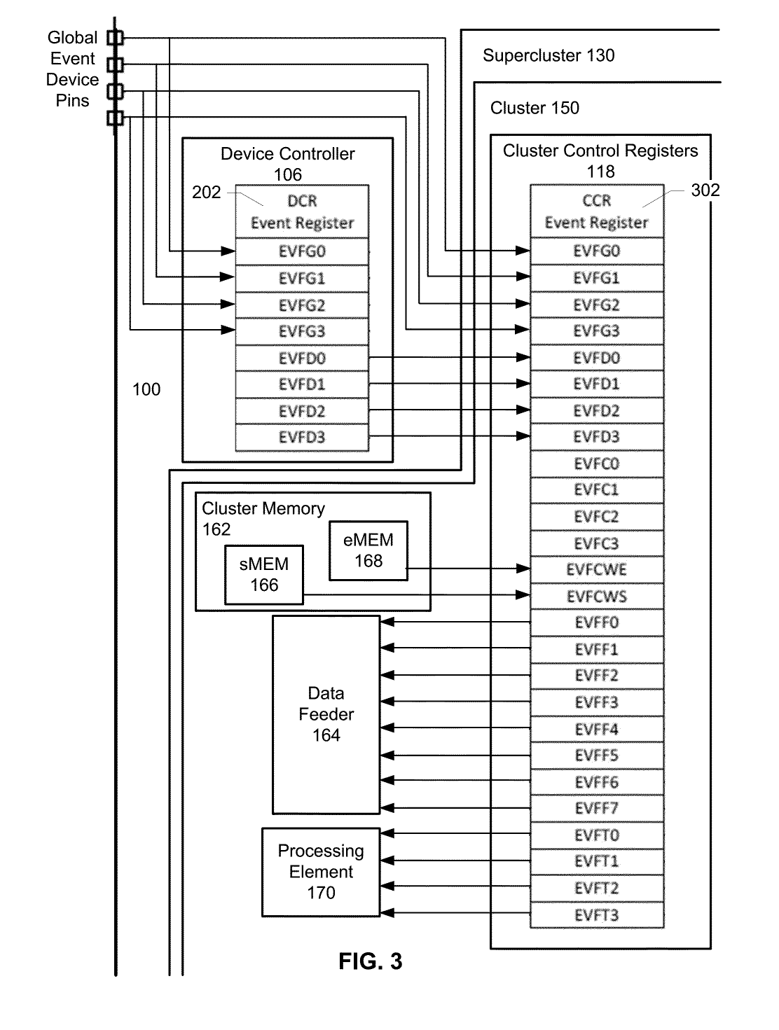

FIG. 3 is a block diagram showing data flow of event signals to and from a cluster 150 of the processor chip 100. A cluster event register 302 includes event flags representing the status of global events, device events, cluster events, eMEM counted wait event, sMEM counted wait event, data feeder events, and processing element events. Although FIG. 3 depicts the cluster event register 302 having event flags for four processing element events (EVFT[3:0]), the cluster event register 302 may include four processing element event flags per processing element in the cluster (e.g., 32 processing element event flags). In such an implementation, asserting a processing element event for a single processing element will not assert a processing element event for any other processing element in the cluster.

The cluster event register 302 may generate data feeder event signals and cluster event signals. The cluster event register 302 may read and clear the flags for the data feeder events, the cluster events, and the eMEM/sMEM counted wait events. The cluster controller 116 (shown in FIG. 1) may use different formats for reading from and writing to the cluster event register 302.

Table 2 below lists field definitions for an example of a 32-bit format for writing to the cluster event register 302. For event flag clear bits in Table 2, writing “1” to the bit position clears the corresponding event flag. For event flag generation, writing “1” to a bit position will generate the corresponding event flag. Writing “0” to any bit position has no effect.

TABLE 2

| Field name | Field | Width | Description |
|---|---|---|---|
| Reserved | 29:30 | 4 | Writes have no effect. Reads return zeroes. |
| EVFCW CLR | 27:26 | 2 | Event flag clear bits for eMEM and sMEM counted wait |
| | | | events (EVFCWE and EVFCWS). |
| Reserved | 25:24 | 2 | Writes have no effect. Reads return zeroes. |
| EVFF CLR | 23:16 | 8 | Event flag clear bits for data feeder events (EVFF[7:0]). |
| EVFF GEN | 15:8 | 8 | Data feeder event flag generation for data feeder events |
| | | | (EVFF[7:0]). Data feeder writes to these fields via packets |
| | | | to the cluster controller. |
| EVFC CLR | 7:4 | 4 | Event flag clear bits for cluster events (EVFC[3:0]). |
| EVFC GEN | 3:0 | 4 | Cluster event flag generation for cluster events |
| | | | (EVFC[3:0]). |

Table 3 below lists field definitions for an example of a 32-bit format for reading from the cluster event register 302. When reading an event flag, “1” indicates the event flag is set, and “0” indicates the event flag is not set.

TABLE 3

| Field name | Field | Width | Description |
|---|---|---|---|
| Reserved | 31:26 | 6 | Writes have no effect. Reads return |
| | | | zeroes. |
| EVFCW | 25:24 | 2 | Status of eMEM and sMEM counted |
| | | | wait events (EVFCWE and EVFCWS). |
| Reserved | 23:16 | 8 | Writes have no effect. Reads return |
| | | | zeroes. |
| EVFF | 15:8 | 8 | Status of data feeder event flags |
| | | | (EVFF[7:0]). |
| Reserved | 7:4 | 4 | Writes have no effect. Reads return |
| | | | zeroes. |
| EVFC | 3:0 | 4 | Status of cluster events (EVFC[3:0]). |

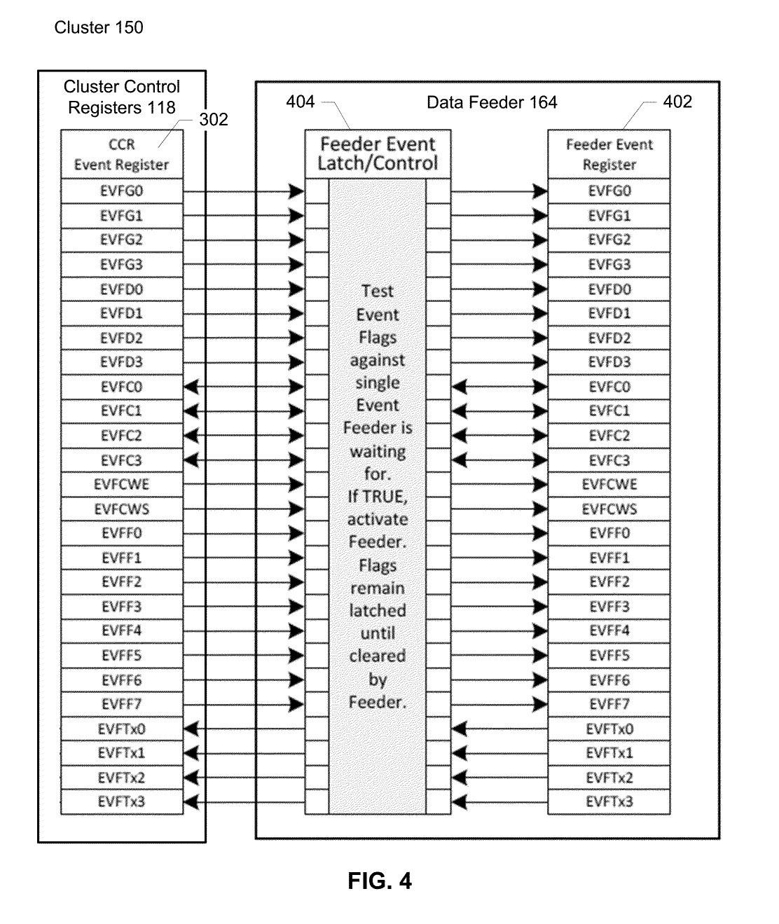

FIG. 4 is a block diagram showing data flow of event signals to and from a data feeder 164 of the processor chip 100. A feeder event register 402 includes event flags representing the status of global events, device events, cluster events, eMEM and sMEM counted wait events, data feeder events, and processing element events. The data feeder 164 can synchronize its operation via events at the cluster, device, and global levels, as well as its own unique set of data feeder events. The eMEM and sMEM counted wait events can be used to trigger the data feeder 164 to begin the next stage/epoch of an algorithm. Data feeder events are provided so that individual processing elements 170, or any set of processing elements 170 within the cluster 150, can synchronize with the data feeder 164.

The data feeder 164 includes feeder event latch/control logic 404 that detects when a single event flag is set. The logic 404 tests the event flags against a single event that the data feeder 164 is waiting for. If the event flag is set, the data feeder 164 may take appropriate action such as begin the next stage of an algorithm.

The data feeder 164 can cause cluster events and processing element events. The data feeder 164 can send packets to the device controller 106 to write the device event control register 204 to generate a device event. The data feeder 164 can send packets to the processing elements to generate packet events.

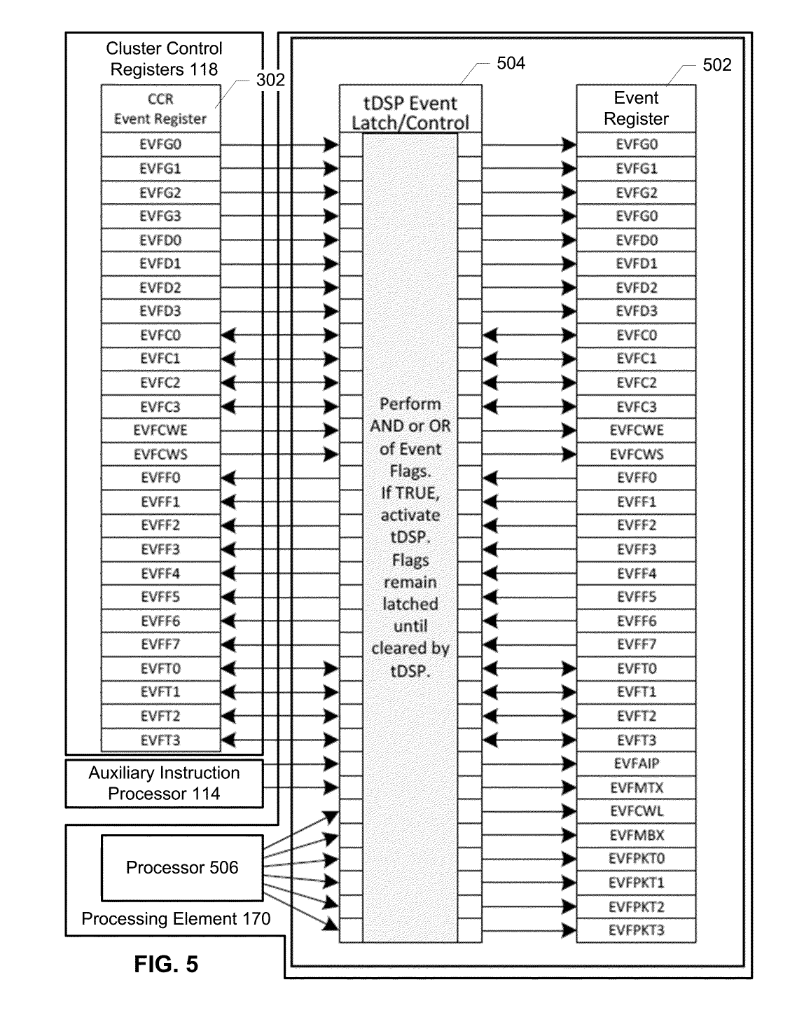

FIG. 5 is a block diagram showing data flow of event signals to and from an event register 502 of a processing element 170 of the processor chip 100. The event register 502 includes event flags representing the status of global events, device events, cluster events, processing element counted wait events, eMEM and sMEM counted wait events, data feeder events, events from other processing elements, an event generated when its mailbox is written, events from the AIP, and packet events. The four unique event flags for events from other processing elements can provide fine-grained synchronization. The event register 502 is a read-only register that is used by the processing element 170 to determine which events it has received. The event register 502 latches any event signal received by the processing element 170. While the processing element 170 is waiting for event flags to be set, the processing element 170 may not be executing instructions, and its clock may be gated to reduce power consumption.

The processing element 170 can wait for either a logical AND of event flags or a logical OR of event flags in the event register 502. The processing element 170 includes event latch/control logic 504 that performs the logical AND or logical OR of the event flags. If the result is TRUE, the processing element 170 is activated. The event flags remain set until cleared by the event latch/control logic 504 of the processing element 170.

The event latch/control logic 504 may include an event flag clear register. The event flag clear register is a write-only register used by the processing element 170 to clear one or more event flags that have been latched in the event register 502. The event flag clear register may be written with a bitmask. Each bit set to “1” in the bitmask will cause the corresponding position in the event register to be cleared. Writing a “0” to any bit has no effect. Writing to a reserved bit has no effect.

The event latch/control logic 504 may include an event flag enable register. The event flag enable register specifies the event flag state that must be satisfied to cause the processing element to be wakened after the processing element executes a SLEEP instruction. The fields of the event register 502, the event flag enable register, and the event flag clear register are nearly identical, except that the event flag enable register includes a MODE bit to control the event flag matching logic. Table 4 below lists the field definitions of the event register 502, the event flag enable register, and the event flag clear register.

TABLE 4

| Field Name | Field | Width | Description |
|---|---|---|---|
| MODE | 31 | 1 | Event flag enable register only (reserved otherwised). |
| | | | MODE = 1: logical OR of all enabled events |
| | | | MODE = 0: logical AND of all enabled events |
| Reserved | 30:26 | 3 | Writes have no effect. Reads return zeroes. |
| EVFMTX | 25 | 1 | MUTEX event. Latched when the AIP has granted the |
| | | | MUTEX to the processing element as a result of a GETMTX |
| | | | instruction. |
| EVFAIP | 24 | 1 | AIP event. Latched when the AIP has completed requested |
| | | | instruction and data and condition codes have been written. |
| EVFPKT[3:0] | 23:20 | 4 | Packet events. Latched when a data packet is received with |
| | | | the corresponding EVFM bit set. |
| EVFMBX | 19 | 1 | Mailbox event. Latched when Mailbox receives data. |
| | | | Unique to each processing element. |
| EVFCWL | 18 | 1 | Processing element counted wait event. Unique to each |
| | | | processing element. |
| EVFCWS | 17 | 1 | sMEM counted wait event. Shared by all processing |
| | | | elements within a single cluster. |
| EVFCWE | 16 | 1 | eMEM counted wait event. Shared by all processing |
| | | | elements within a single cluster. |
| EVFT[3:0] | 15:12 | 4 | Processing element events. Unique to each processing |
| | | | element. |
| EVFC[3:0] | 11:8 | 4 | Cluster events. Shared by all processing elements within a |
| | | | single cluster. |
| EVFD[3:0] | 7:4 | 4 | Device events. Shared by all clusters. |
| EVFG[3:0] | 3:0 | 4 | Global events. Sourced external to the processor chip. |

The processing element 170 can write to the cluster event register 302 to cause cluster, data feeder, and processing element events. The processing element 170 can write to the device event control register 204 (shown in FIG. 2) to cause a device event. The processing element 170 can also send data packets that contain payload data and a header that has a specific field to any other processing element to set packet event flags. Table 5 below lists field definitions for an example of a data packet for setting packet event flags. The field specifies specific bits within the packet header. A processing element can receive multiple types of data with each type setting a specific event flag number. The processing element can then wait on a logical AND of all the event flags knowing that when it is awakened it has received all data required to fulfill a task.

TABLE 5

| Field name | Field | Width | Description |
|---|---|---|---|
| PADDR1 | 31:0 | 32 | Physical address for device-level accesses. |
| PADDR2 | 26:0 | 27 | Physical address for cluster-level accesses. |
| PADDR3 | 19:0 | 20 | Physical address for processing |
| | | | element-level accesses. |
| EVFM3 | 23 | 1 | Packet event flag mask. A value of “1” |
| EVFM2 | 22 | 1 | in any bit position asserts the |
| EVFM1 | 21 | 1 | corresponding packet event (EVFPKT). |
| EVFM0 | 20 | 1 | Only present for processing |
| | | | element-level accesses. |

An event generation register may be used to generate processing element events to be distributed to processing elements within a cluster. A write data packet can generate up to 32 processing element events with a single write, as the eight fields in the event generation register are masks. Table 6 below lists field definitions for the event generation register. To generate an event, a “1” can be written to the corresponding bit.

TABLE 6

| Field name | Field | Width | Description |
|---|---|---|---|
| Processing | 31:28 | 4 | EVFT[3:0] event generation for |
| element 7 | | | processing element 7. |
| Processing | 27:24 | 4 | EVFT[3:0] event generation for |
| element 6 | | | processing element 6. |
| Processing | 23:20 | 4 | EVFT[3:0] event generation for |
| element 5 | | | processing element 5. |
| Processing | 19:16 | 4 | EVFT[3:0] event generation for |
| element 4 | | | processing element 4. |
| Processing | 15:12 | 4 | EVFT[3:0] event generation for |
| element 3 | | | processing element 3. |
| Processing | 11:8 | 4 | EVFT[3:0] event generation for |
| element 2 | | | processing element 2. |
| Processing | 7:4 | 4 | EVFT[3:0] event generation for |
| element 1 | | | processing element 1. |
| Processing | 3:0 | 4 | EVFT[3:0] event generation for |
| element 0 | | | processing element 0. |

The AIP 114 may be a co-processing element available for use by all processing elements 170 within the same cluster 150. Because the AIP 114 is a shared resource, even moderate use and contention for AIP functions may result in significant delays in AIP operations returning their results. When a processing element 170 executes an instruction that is performed by the AIP 114, the per-processing element AIP event can be used to synchronize with the AIP 114 returning the result. Failure to synchronize with the AIP 114 may result in the data and status being missed or overwritten.

To achieve synchronization between a processing element 170 and the AIP 114, the processing element 170 calls the AIP 114 to perform a function, enables waiting on the AIP event signal, and waits for the AIP event signal. When the AIP data and instruction status is available for use by the processing element 170, the AIP 114 transmits the AIP event signal to the processing element 170. Upon receiving the AIP event signal, the processing element 170 resumes execution of the instruction. In some implementations, the processing element 170 goes to sleep while waiting for the AIP event signal and wakes up upon receiving the AIP event signal. During the sleep period, event logic or hardware external to the processing element 170, e.g., event latch/control logic 504 of FIG. 5, detects that the AIP event signal has been received and wakes the processing element 170. In other implementations, because there could be many cycles between the processing element 170 calling the AIP 114 and the AIP 114 returning the result depending on the contention for the AIP 114, a programmer may be able to interpose other instructions to be processed by the processing element 170 during those cycles where those other instructions have no interdependency with the AIP instruction's result and will not overwrite the AIP instruction's destination register.

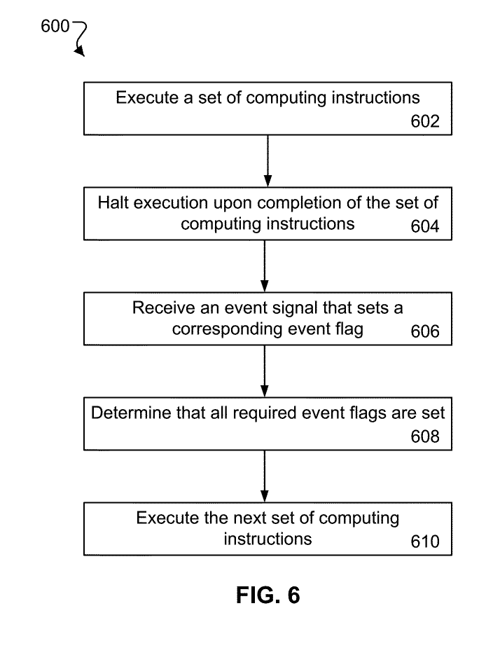

FIG. 6 is a flowchart showing an example of a process 600 for synchronizing execution of instructions in a computing system, such as the processor chip 100 of FIGS. 1-5. Any number of processing elements in the computing system can perform the process 600. The process may include any combination of the details discussed above.

A processing element of a cluster executes a set of computing instructions (602) and halts execution upon completion of the set of computing instructions (604). The processing element waits until it receives, from a cluster event register of the same cluster, one or more event signals that set one or more corresponding event flags in the element event register (606). A device event status register of the computing system can send signals or data packets to the processing cluster to trigger the cluster event register to provide the one or more event signals. A data feeder, a memory device (e.g., eMEM or sMEM), and a processing element within the same processing cluster as the cluster event register can send signals or data packets to the processing cluster to trigger the cluster event register to provide the one or more event signals.

The processing element can wait for either a logical AND of event flags or a logical OR of event flags in the element event register. The processing element performs the logical AND or logical OR of the event flags. If the processing element determines that the result is TRUE indicating that all required event flags are set (608), the processing element executes the next set of instructions (610).

Implementations of the subject matter and the operations described in this specification can be implemented in digital electronic circuitry, or in computer software, firmware, or hardware, including the structures disclosed in this specification and their structural equivalents, or in combinations of one or more of them.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system comprising:
a device controller comprising a device event control register and a device event status register, the device event status register configured to store bits corresponding to (i) a global event signal provided by an external source and (ii) a device event signal provided by the device event control register;
a plurality of processing clusters including a first processing cluster that is connected with the device controller, the first processing cluster comprising a cluster event register, the cluster event register configured to store bits corresponding to (i) the global event signal provided by the external source, (ii) the device event signal provided by the device event control register, and (iii) a cluster event signal; and
a plurality of processing elements including a first processing element that is connected with the cluster event register, the first processing element comprising an element event register, the element event register configured to store bits corresponding to (i) the global event signal provided by the external source, (ii) the device event signal provided by the device event control register, (iii) the cluster event signal provided by the cluster event register, and (iv) a processing element event signal.

2. The system of claim 1, wherein the device event control register is configured to provide the device event signal based on data received from one of the external source, a processor of the device controller, a processing element of the plurality of processing elements, or a data feeder of a cluster memory.

3. The system of claim 1, wherein the cluster event register is configured to provide the cluster event signal based on data received from one of the external source, a processor of the device controller, a processing element of the plurality of processing elements, or a data feeder of a cluster-level memory.

4. The system of claim 1, wherein the cluster event register is configured to provide the processing element event signal based on data received from one of the external source, a processor of the device controller, a processing element of the plurality of processing elements, or a data feeder of a cluster-level memory.

5. The system of claim 1, wherein each of the device event status register, the cluster event register, and the element event register comprises asynchronous latches.

6. The system of claim 1, wherein each processing element of the plurality of processing elements comprises an element event register, and the cluster event register is configured to provide the cluster event signal and the processing element event signal to each element event register of each processing element of the plurality of processing elements.

7. The system of claim 1, wherein a processor of the device controller is configured to poll the device event status register, execute an interrupt routine, or sleep based on values of the bits stored in the device event status register.

8. The system of claim 1, wherein the first processing element further comprises event logic that is configured to:
cause a change in a power consumption mode from a normal mode to a sleep mode of the first processing element when the first processing element executes a sleep command,
while the first processing element is in the sleep mode, detect that an event condition is satisfied based on values of the bits stored in the element event register, and
upon detecting that the event condition is satisfied, switch the power consumption mode of the first processing element from the sleep mode to the normal mode.

9. The system of claim 8, wherein the event logic of the first processing element is configured to detect that the event condition is satisfied based on a logical AND of the values of the bits stored in the element event register.

10. The system of claim 8, wherein the event logic of the first processing element is configured to detect that the event condition is satisfied based on a logical OR of the values of the bits stored in the element event register.

11. The system of claim 1, wherein the first cluster comprises a state memory and an execution memory, and the element event register is further configured to store bits corresponding to memory event signals provided by the state memory and the execution memory.

12. The system of claim 1, further comprising:
a cluster memory connected with the cluster event register, the cluster memory comprising a data feeder and a data feeder event register, the data feeder event register configured to store bits corresponding to (i) the global event signal provided by the external source, (ii) the device event signal provided by the device control register, (iii) the cluster event signal provided by the cluster event register, and (iv) a data feeder event signal.

13. The system of claim 12, wherein the cluster event register is configured to provide the data feeder event signal based on data received from one of the external source, a processor of the device controller, a processing element of the plurality of processing elements, or the data feeder.

14. The system of claim 12, wherein the data feeder is configured to begin execution of a set of instructions based on values of the bits stored in the data feeder event register.

15. The system of claim 12, wherein the cluster memory comprises one or more memory devices, and the data feeder event register is further configured to store bits corresponding to memory event signals provided by the one or more memory devices.

16. A method of synchronizing execution of instructions in a computing system, the method comprising:
in a computing system comprising a plurality of processing clusters, a first processing cluster of the plurality of processing clusters comprising a plurality of processing elements, the plurality of processing elements being configured to receive event signals from sources at levels higher in a system hierarchy than the plurality of processing elements, a first processing element of the plurality of processing elements comprising a first element event register, performing the following by the first processing element:
executing a first set of computing instructions;
halting execution upon completion of the first set of computing instructions;
receiving, from a source at a level higher in the system hierarchy, one or more event signals that set one or more corresponding event flags in the first element event register;
determining that all required event flags are set in the first element event register; and
in response to the determining, executing a second set of computing instructions.

17. The method of claim 16, further comprising:
in the computing system further comprising a second processing element of the plurality of processing elements, the second processing element comprising a second element event register, performing the following by the second processing element:
executing a third set of computing instructions;
halting execution upon completion of the third set of computing instructions;
receiving, from the source at the level higher in the system hierarchy, the one or more event signals that set one or more corresponding flags in the second element event register;
determining that all required event flags are set in the second element event register; and
in response to the determining, executing a fourth set of computing instructions.

18. The method of claim 16, further comprising:
in the computing system comprising the first processing cluster and further comprising a device event status register, the first processing cluster further comprising a cluster event register, the device event status register being connected to the plurality of clusters and being configured to distribute event signals to the plurality of processing clusters, performing the following by the cluster event register:
receiving, from the device event status register, one or more event signals that trigger the cluster event register to provide the one or more event signals that set the one or more corresponding flags in the first element event register.

19. The method of claim 16, further comprising:
in the computing system comprising the first processing cluster, the first processing cluster further comprising a data feeder and a cluster event register, performing the following by the cluster event register:
receiving, from the data feeder, one or more event signals that trigger the cluster event register to provide the one or more event signals that set the one or more corresponding flags in the first element event register.

20. The method of claim 16, further comprising:
in the computing system comprising the first processing cluster, the first processing cluster further comprising one or more memory devices and a cluster event register, performing the following by the cluster event register:
receiving, from the one or more memory devices, one or more event signals that trigger the cluster event register to provide the one or more event signals that set the one or more corresponding flags in the first element event register.

21. The method of claim 16, further comprising:
in the computing system comprising the first processing element and further comprising a second processing element of the plurality of processing elements, the first processing element further comprising a cluster event register, performing the following by the cluster event register:
receiving, from the second processing element, one or more event signals that trigger the cluster event register to provide the one or more event signals that set the one or more corresponding flags in the first element event register.

22. A system comprising:
at a highest level of a system hierarchy, means for storing bits corresponding to (i) a global event signal provided by an external source and (ii) a device event signal provided by a source at the highest level of the system hierarchy;
at an intermediate level of the system hierarchy, means for storing bits corresponding to (i) the global event signal provided by the external source, (ii) the device event signal provided by the source at the highest level of the system hierarchy, and (iii) a cluster event signal; and
at a lowest level of the system hierarchy, means for storing bits corresponding to (i) the global event signal provided by the external source, (ii) the device event signal provided by the source at the highest level of the system hierarchy, (iii) the cluster event signal provided by a source at the intermediate level of the system hierarchy, and (iv) a processing element event signal.
